(19) United States
(12) Patent Application Publication
(10) Pub. No.: US 2020/0242669 A1
(43) Pub. Date: Jul. 30, 2020

(54) SYSTEMS AND METHODS FOR PROVIDING PERSONALIZED TRANSACTION RECOMMENDATIONS

(71) Applicant: CAPITAL ONE SERVICES, LLC, McLean, VA (US)

(72) Inventors: William Carroll, Huntingtown, MD (US); Abdelkader Benkreira, Arlington, VA (US); Michael Mossoba, Arlington, VA (US); Joshua Edwards, Philadelphia, PA (US)

(73) Assignee: CAPITAL ONE SERVICES, LLC, McLean, VA (US)

(21) Appl. No.: 16/260,046

(22) Filed: Jan. 28, 2019

(51) Int. Cl. G06Q 30/02; G06Q 30/06; G06N 20/00; G06Q 50/00

(52) U.S. Cl. CPC G06Q 30/0279; G06Q 50/01; G06N 20/00; G06Q 30/0631

(57) ABSTRACT

The present disclosure relates to systems and methods for recommending transaction amounts including: receiving a request for a transaction recommendation associated with a customer; receiving a plurality of traits associated with the customer; identifying a characteristic associated with one or more groups of customers based on the plurality of traits; automatically generating a transaction model associated with the identified characteristic associated with the one or more groups of customers; ranking the potential transactions; and generating at least one transaction recommendation for the customer based on the transaction model.

### TECHNICAL FIELD

The present disclosure relates generally to the field of generating targeted recommendations to customers based on the customer's social media activity and behavior of similar customers.

### BACKGROUND

As more and more data is available on behaviors, habits, and social media presence of individuals, customers have become increasingly accustomed to targeted and personalized services. Through the emergence of artificial intelligence (AI) and machine learning (ML), organizations are better able to provide personalized services to customers.

Individuals make charitable donations for many reasons, yet finding an organization to which to donate can be challenging. Smaller charitable organizations may not have the Internet presence necessary to show up in search engine results, larger organizations may have lesser known local branches, or it may be difficult to ascertain how an organization dispenses donations.

Accordingly, there exists a need for systems to implement AI and or ML principles to provide a seamless and personalized donation platform.

### SUMMARY

In view of the foregoing, embodiments of the present disclosure describe systems and methods for generating transaction recommendations using ML.

Consistent with the present embodiments, a system for recommending transactions is provided. The system may include at least one machine-readable memory storing computer-executable instructions and at least one processor configured to execute the instructions to perform operations. The operations may include receiving a request for a transaction recommendation associated with a specified customer; receiving a set of traits associated with the specified customer; identifying a characteristic associated with a group of customers based on the set of traits; generating a transaction model associated with the identified characteristic, the transaction model indicating potential transaction information associated with an entity by the customer group; determining a set of potential transactions using the transaction model; ranking the potential transactions using the transaction model; and generating a transaction recommendation for the specified customer based on the transaction model, the transaction recommendation including a transaction amount and a transaction recipient.

Consistent with the present embodiments, a computer-implemented method for recommending transaction is provided. The method may include: receiving a request for a transaction recommendation associated with a specific customer via a computer network; receiving a set of traits associated with the specified customer; identifying, via one or more processors, a characteristic associated with a group of customers based on the set of traits; generating, via the one or more processors, a transaction model associated with the identified characteristic, the transaction model indicating potential transaction information associated with an entity by the customer group; determining a set of potential transactions using the transaction model; ranking the potential transactions using the transaction model; and generating a transaction recommendation for the specified customer based on the transaction model.

Consistent with the present embodiments, a non-transitory computer-readable medium may store instructions that, when executed by at least one processor, cause the at least one processor to perform operations including: receiving a request for a transaction recommendation associated with a customer via a computer network; receiving a set of traits associated with the customer; identifying, via one or more processors, a characteristic associated with a group of customers based on the set of traits; generating, via the one or more processors, a transaction model associated with the identified characteristic, the transaction model indicating potential transaction information associated with an entity by the customer group; determining a set of potential transactions using the transaction model; ranking the potential transactions using the transaction model; and generating at least one transaction recommendation for the customer based on the transaction model.

It is to be understood that the foregoing general description and the following detailed description are example and explanatory only, and are not restrictive of the disclosed embodiments.

### BRIEF DESCRIPTION OF THE DRAWINGS

The accompanying drawings, which comprise a part of this specification, illustrate several embodiments and, together with the description, serve to explain the principles disclosed herein. In the drawings:

FIG. 1 illustrates an exemplary system for generating personalized donation recommendations, consistent with disclosed embodiments.

FIG. 2 is a block diagram of a financial service provider system of the recommendation system of FIG. 1.

FIG. 3 is a flowchart of an exemplary method for performing customer segmentation, consistent with disclosed embodiments.

FIG. 4 is a flowchart of an exemplary method for associating customers with customer groups, consistent with disclosed embodiments.

FIG. 5 is a flowchart of an exemplary method for generating transaction models based on customer clusters, consistent with disclosed embodiments.

FIG. 6 is a flowchart of an exemplary method for generating transaction recommendations, consistent with disclosed embodiments.

### DETAILED DESCRIPTION

The disclosed embodiments relate to systems and methods for recommending transactions. Embodiments of the present disclosure may be implemented using a general-purpose computer. Alternatively, a special-purpose computer may be built according to embodiments of the present disclosure using suitable logic elements.

Described herein are systems and methods for recommending transaction amounts and entities to receive the transaction amounts, based on a user's financial habits and social media behavior. Current digital technology is capable of collecting vast amounts of data from its users. Many entities analyze this user data to provide personalized, targeted advertisements and/or offers to users. However, there exists a need for systems and methods configured to provide personalized suggestions of charitable organizations to which a user may wish to donate, and to suggest a donation amount and/or frequency based on the user's financial activity.

Consistent with embodiments described herein, a transaction may be any financial transaction, for example, a purchase, a transfer of funds, a payment, and the like. The entities may include any entity capable of receiving a financial transfer. For example, an entity may be a financial service provider, a merchant, a person associated with a financial account, a charitable organization, and the like.

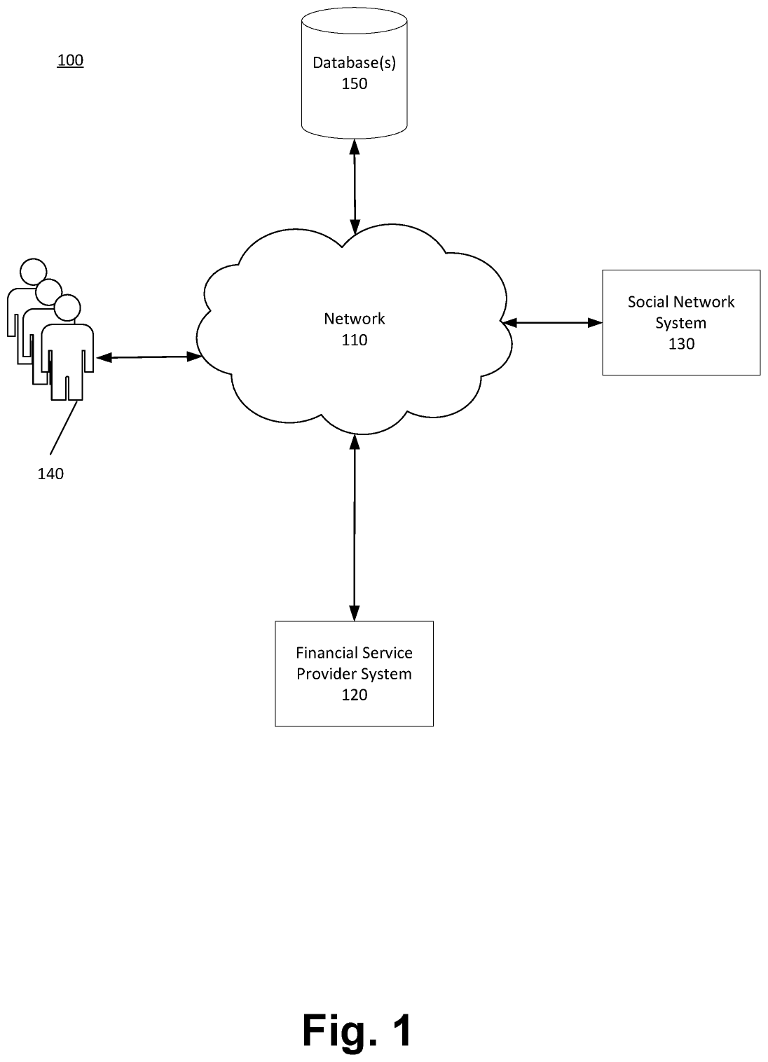

FIG. 1 is a diagram illustrating an exemplary system 100 for recommending customized transactions. For example, the recommendation may include a recommended charitable organization based on a user's social media behavior and transaction history. A recommendation may also include a recommended donation amount based on the user's demographic information and/or financial account information. The components arranged in FIG. 1 may vary. System 100 may include a network 110, a financial service provider system 120, a social network provider system 130, customer 140, and a database 150. System 100 may further include any entity or source of information capable of providing information or characteristics regarding individuals or groups of individuals. In some embodiments, an individual may be a customer, e.g., a customer of a financial service provider.

Network 110 may be any type of network configured to provide communications between components of system 100. For example, network 110 may be a network (including infrastructure) that provides communications, exchanges information, and/or facilitates the exchange of information, such as the Internet, a Local Area Network, or other suitable connection(s) that enables system 100 to send and receive information between the components of system 100. In other embodiments, components of system 100 may communicate directly through a dedicated communication medium.

Financial service provider system 120 may be a system that is associated with an entity that provides and manages financial service accounts, such as a bank, credit card company, etc. Financial service provider system 120 may additionally determine financial characteristics of customers according to finely defined sociographic segments. In one embodiment, financial service provider system 120 may include one or more computing systems that are located at a central location or may include computing devices that are distributed (locally or remotely). In one example, financial service provider system 120 may include one or more processors that are configured in a server to execute software instructions stored in one or more memory devices to perform one or more operations consistent with the disclosed embodiments.

In some embodiments, financial service provider system 120 may be a banking platform through which customers perform transactions. For example, financial service provider system 120 may store, for each customer transaction, a transaction amount, a transaction recipient (e.g., merchant, individual, organization, etc.), a transaction date, etc. In some embodiments, financial service provider system may receive transaction data from one or more credit card processing systems.

Social network provider system 130 may be a system associated with a social network comprising a web-based online community. Although disclosed embodiments are discussed primarily in the context of coordination with online social networks to determine spending characteristics of a customer, any source of information regarding a customer and the customer's spending tendencies is contemplated.

Customer 140 may be a customer of financial service provider system 120 and/or a user of social network provider system 130. Customer 140 may communicate with financial service provider system 120 or social network provider system 130 using any suitable computer device or system (not shown). Customer 140 may also be an advertising user wishing to employ disclosed embodiments to determine suitable persons or groups of persons from which to solicit, using targeted advertising.

Database 150 may include one or more memory devices that store information and are accessed and/or managed through network 110. By way of example, database(s) 150 may include Oracle™ databases, Sybase™ databases, or other relational databases or non-relational databases, such as Hadoop sequences files, HBase, or Cassandra. The databases or other files maybe maintained by the financial service provider and/or by a third-party and may include, for example, data and information related to customer accounts, customer demographic information, publicly available information, etc. Systems and methods of the disclosed embodiments, however, are not limited to separate databases. Database 150 may include computing components (e.g., database management system, database server, etc.) configured to receive and process requests for data stored in memory devices of database(s) 150 and to provide data from database 150.

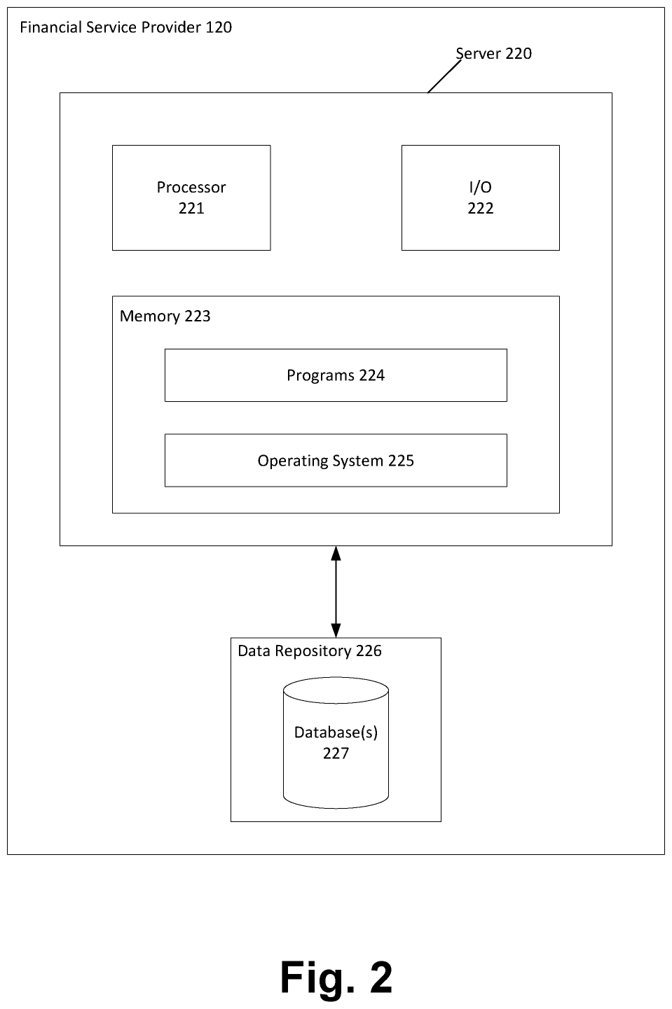

FIG. 2 illustrates an exemplary financial service provider system 120. In one embodiment, system 120 may include a server 220 having one or more processors 221, one or more memories 223, and one or more input/output (I/O) devices 222. Alternatively, server 220 may take the form of a general-purpose computer, a mainframe computer, or any combination of these components. Server 220 may be standalone, or it may be part of a subsystem, which may be part of a larger system.

Processor 221 may include one or more known processing devices, such as a microprocessor from the Pentium™ or Xeon™ family manufactured by Intel™, the Turion™ family manufactured by AMD™, or any of various processors manufactured by Sun Microsystems.

Memory 223 may include one or more storage devices configured to store instructions which when executed by processor 221 perform operations related to disclosed embodiments. For example, memory 223 may be configured with programs 224 that perform several operations when executed by processor 221. Therefore, the disclosed embodiments are not limited to separate programs or computers configured to perform dedicated tasks. For example, memory 223 may include a single program 224 that performs the functions of the server 120, or program 224 may include multiple programs. Additionally, processor 221 may execute one or more programs located remotely from server 220. For example, financial service provider system 120 may access one or more remote programs that, when executed, perform operations related to disclosed embodiments.

Memory 223 may also be configured with an operating system 225 that performs several operations well known in the art when executed by server 220. By way of example, the operating system may be Microsoft Windows™, Unix™ Linux™, Solaris™, Apple OSX, or some other operating system. The choice of operating system, and even the use of an operating system, is not critical to any disclosed embodiment.

I/O devices 222 may be one or more devices that are configured to allow data to be received and/or transmitted by server 220. I/O devices 222 may include one or more digital and/or analog communication devices that allow server 220 to communicate with other machines and devices, such as devices of customers 140.

Server 220 may also be communicatively connected to one or more data repositories 226 through network 110 as shown in FIG. 2. Data repository 226 may include one or more files or databases 227 that store information and are accessed and/or managed through server 220. Data repository 226 may include, for example, database(s) 150. By way of example, databases 227 may be Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, financial service provider system 120 may include data repository 226. Alternatively, data repository 226 may be located remotely from financial service provider system 120.

In some embodiments, database 227 may store one or more reference tables of charitable organizations and associated labels, or “tags.” For example, an organization may be associated with tags indicating a geographic location served by the organization, a religious affiliation of the organization, a population served by the organization, etc. In some embodiments, database 227 may store a “trustworthiness” rating of the organization indicating, for example, the percent of each donation that is actually received by the population served and/or the amount of transparency with which the organization operates. Database 227 may also store a non-profit status associated with each organization.

In some embodiments, server 220 may use one or more application program interfaces (APIs) to receive organization data and to populate and/or update database 227 with a list of charitable organizations. For example, server 220 may receive data, e.g., via an API or web scraping, indicating the non-profit tax status for each charity stored in database 227. In another embodiment, server 220 may receive and store, for example, a ranking, trustworthiness score, efficiency score, etc. received from a watchdog organization (e.g., CharityWatch, Charity Navigator, GuideStar, etc.). In some embodiments, the system may only recommend organizations with a rating or score greater than a particular threshold. For example, the system may recommend only charities spending above a threshold percentage of donations on their respective charitable programs. In another example, the system may recommend charities that spend below a threshold percentage of donations on fundraising and/or operational costs.

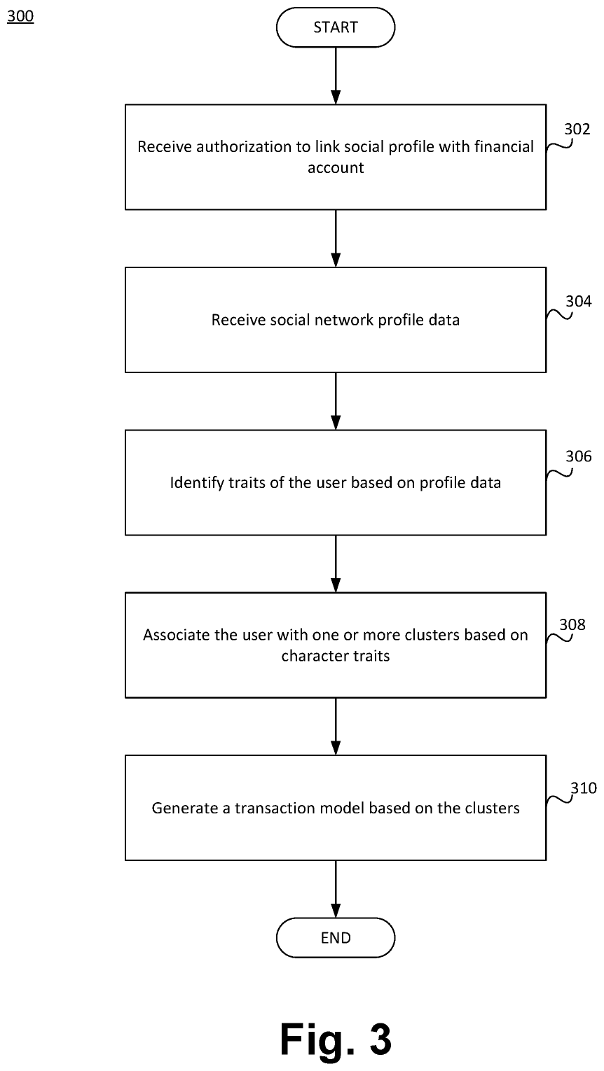

FIG. 3 is a flow diagram of an exemplary process 300 for generating donation recommendations for a customer of a financial service provider, consistent with disclosed embodiments.

In step 302, server 220 may receive authorization from a customer (such as customer 140) to link a financial account associated with the customer with a social network account associated with the customer via network 110. In other embodiments, the customer may be prompted to link a social network account with the financial account during an application process or while executing a transaction at an automated teller machine (ATM) or via a web-based application on a personal computing device.

In some embodiments, server 220 may identify one or more social networks associated with the customer. Server 220 may obtain social profile data using an authorization key provided by the one or more social networks upon the authorization of the customer to link the customer's social network profile(s) with the customer's financial account(s). For example, the social networks may typically notify the customer that an application, such as an application provided by financial service provider system 120, is requesting permission to access additional profile data from the social network. The customer may grant or refuse permission to allow access to the additional profile data. If the customer grants permission, the social network may provide an authorization key to the server that may be used to access the additional profile information. In some embodiments, server 220 may request profile information associated with the customer for the one or more social networks. In some embodiments, server 220 may receive customer social network activity information at predetermined intervals (e.g., once per day, once per week, etc.).

Upon authorization, server 220 may receive the requested profile information associated with the customer from each of the one or more social network system(s) 130. In some embodiments, server 220 may store the received profile information in a memory, such as for example, data repository 226. In some embodiments, server 220 may query one or more social network systems using an application programming interface (API) to receive data indicative of the customer's social network activity. In another embodiment, server 220 may perform web scraping while logged in to the customer's account to retrieve social network activity data.

In step 304, server 220 may receive data or information associated with the customer's social network profile. Received information may include, for example, information about the customer's connections (or “friends”) on the social network, one or more virtual interest groups to which the customer belongs, and/or customer activity on the social network. In some embodiments, server 220 may receive data indicative of content consumed by the customer and/or content shared with the customer. Content may be shared with the customer, for example, by friends or by companies or groups the customer has an interest in, or is likely to have an interest in.

Based on the received social network profile information, server 220 may identify one or more “traits” of customer 140 (step 306). In some embodiments, traits of customer 140 may include preferences for one or more charitable organizations, demographic information, and/or general interests. In some embodiments, server 220 may receive information from database(s) 150, which may include third-party data such as publicly available records and/or credit reports associated with the customer. In other embodiments, server 220 may receive customer financial and/or demographic information from database(s) 227. In other examples, a trait may include average monthly spending, yearly income, geographic location, and the like.

In some embodiments, the traits may be determined based on an analysis of the customer's social network activity. For example, a trait may be based on positive customer feedback (or “likes”). Thus, a trait indicating that a customer likes animals may be based on the customer following one or more pet services accounts (e.g., a veterinary clinic, the ASPCA, a pet store, etc.) and/or on the number of times a customer “likes” pet-related content on the social network. The trait, e.g., “interest in animals” may be associated with one or more tags stored in database 227, which are in turn associated with one or more organizations (e.g., the ASPCA, one or more animal shelters, breed-specific rescue organizations, etc.).

In some embodiments, traits of customer 140 may include interests indicated by the topics that the customer actively discusses on social network provider system 130. In other embodiments, traits of customer 140 may include interests indicated by the topics that the customer regularly views or otherwise passively engages with on social network provider system 130. In some embodiments, server 220 may receive social network data, for example, posts shared by the customer and/or posts shared by accounts that the customer follows, and apply natural language processing (NLP) techniques to identify recurring concepts and sentiments. In some embodiments, server 220 may identify one or more recurring concepts the customer has in common with one or more friends or with an account followed by the customer. Server 220 may also apply NLP techniques to identify recurring themes in content the customer regularly views or passively engages with. Interests may further be identified based on recurring topics that the customer “likes” or shares. For example, server 220 may identify a stronger interest of the customer in content associated with a topic if the customer “likes” said content more frequently than content associated with a different topic. Server 220 may also determine a strength of interest in a topic based on the frequency with which associated content is shared by friends or organizations, the frequency with which the customer shares associated content, and/or the frequency with which the customer and/or the customer's friends interact with associated content (e.g., by commenting on said content, saving said content, clicking through a link, etc.).

Further, in some embodiments, traits of customer 140 may include purchasing behavior on social network provider system 130, such as applications, games, gifts, or any other purchase that may be transacted on or using the social network. In some embodiments, purchasing behavior may be included in the customer's purchasing history. Server 220 may use purchase history of the customer from financial service provider system 120 to provide additional transaction information associated with social network purchases made by the customer. In another embodiment, server 220 may receive transaction information from a mobile payment application (e.g., Venmo™, PayPal™, Square™, Zelle™, etc.) that is linked to one or more of the customer's social network accounts and/or that the customer has authorized the financial service provider system 120 to access. It is understood that this list is not intended to be limiting, and server 220 may identify any observable trait of customer 140 via social network provider system 130.

In step 308, server 220 may associate a customer, such as customer 140, with one or more groups, or “clusters,” of customers, based on the identified traits of the customer. Server 220 may also consider information from other sources, including information associated with a financial account configured for the customer by financial service provider system 120 and/or customer information stored in a third-party database. Server 220 may associate customers 140 with multiple groups of varying specificity. For example, server 220 may determine that a customer 140 should be associated with a cluster such as: “20-30: local,” indicating that the customer is between 20 and 30 years old and regularly interacts with social media accounts and/or content associated with organizations within a certain geographic area (e.g., a metropolitan area or a predetermined radius from the customer's home address). In other examples, clusters may be based on any number or combination of traits including, but not limited to, average annual salary, geographic location, previous transactions with non-profit organizations, average monthly spending, level of education, occupation, etc. In other embodiments, traits may include locations or organizations where the customers in the cluster spend disposable income.

It is understood that these clusters are presented as nonlimiting examples, and that customers such as customer 140 may be clustered by any observable characteristic capable of providing insight on financial spending, customer interests, and/or charitable behavior.

In step 310, server 220 may generate a transaction model for each of the defined clusters. Server 220 may be configured to use the transaction models to, for example, dynamically identify characteristics of an individual customer or group of customers based on traits of that individual or group. In some embodiments, a characteristic may include preferences for one or more charitable organizations, a likelihood of making a charitable donation to a particular organization, a likelihood of making a donation of a particular amount, and the like. It is understood that these characteristics are presented as non-limiting examples.

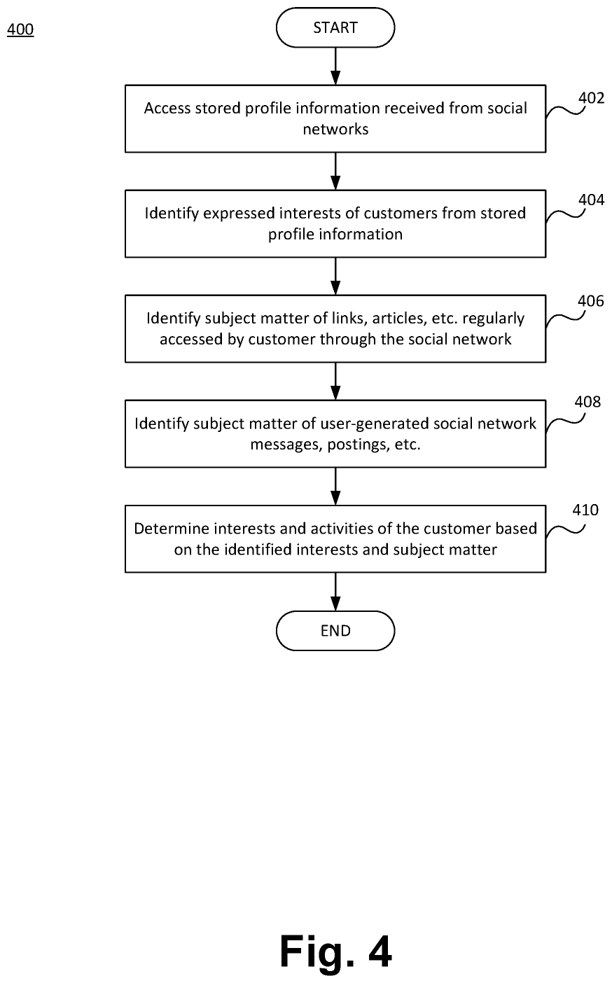

FIG. 4 is a flowchart of an exemplary method 400 for identifying one or more traits of a customer, e.g., as described in step 306 of method 300, consistent with disclosed embodiments.

In step 402, server 220 may access stored profile information received from one or more social network provider systems 130 for one or more customers 140. Stored profile information may include a stored “token” for accessing the one or more customers' social network data via an application programming interface (API) of the social network or may include previously collected profile information. In some embodiments, stored profile information may include any information required to acquire data from the customer's profile, e.g., a username to access public data (for example, a Twitter handle or YouTube account name), a username and password, and/or an authentication token.

In step 404, server 220 may identify one or more expressed interests of the customer (such as customer 140) based on the stored profile information. For example, the received social network profile information may include information regarding a section of a social network profile entitled “Interests,” containing a plurality of personal interests of customer 140. The received social network information may also include one or more of the metrics previously discussed, for example, “likes,” engagement with accounts related to a certain topic or interest, etc. Social network information may further include the frequency with which the customer engages in activities (for example, by “following,” “liking,” posting, or “tagging” content related to a particular topic).

In step 406, server 220 may identify the subject matter of one or more links, articles, and the like that customer 140 has accessed via the social networking site. For example, server 220 may determine that customer 140 regularly follows links associated with articles on restoring automobiles. According to some embodiments, publishers of online media may embed a third-party cookie from the social network that permits the social network to detect the links, articles, and the like that customer 140 has accessed. In some embodiments, the server 220 may use NLP techniques to identify key elements (nouns) in the content accessed by the customer. Based on the identified elements, server 220 may use additional NLP techniques (e.g., synonym matching) to associate those elements across different articles. Thus, server 220 may associate key elements, e.g., “Ford F150” and “Dodge Ram,” as kinds of trucks, and determine that the customer has read repeated articles about an interest, e.g., trucks. In another example, the customer may publish a post about a “Ford F150,” and a friend of the customer may publish a post about a “Dodge Ram.” Server 220 may determine, using the above described method, that the customer and said friend share an interest in trucks.

In step 408, server 220 may identify the subject matter of user-generated messages, blog entries, postings, etc. In some embodiments, server 220 may use content classification services that categorize articles, for example, to identify the subject matter of the user-generated content. For example, server 220 may determine that customer 140 regularly comments on a blog associated with a particular sports team.

In step 410, server 220 may determine the interests and activities of customer 140 based on the identified subject matter of steps 402-406. Server 220 may further identify specific traits of customer 140 based on the determined interests and activities, such as organization preferences, geographic preferences, and/or “cause” preferences (e.g., preferences for organizations providing charitable services to children, animals, refugees, national disaster victims, etc.).

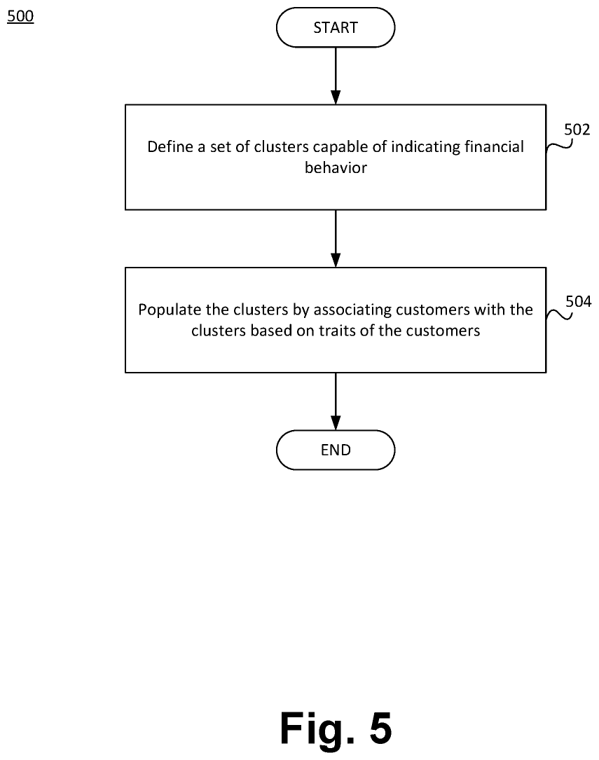

FIG. 5 is a flowchart of an exemplary method 500 for generating customer groups, consistent with disclosed embodiments.

In step 502, server 220 may define a plurality of customer groups, or clusters, capable of indicating transaction (for example, charitable donation) behavior. In some embodiments, server 220 may employ known cluster analysis schemes and/or groupings, such as PRIZM codes, BlueKAI, and/or any other behavior segmentation lists. In other embodiments, server 220 may create the clusters/segments. As noted above, clusters may be defined as groups of users with the highest degree of similarity based on the desired dimensions. This may be based on, for example, interest, actions, financial behavior, demographics, or other profile information known to server 220. In some embodiments, the above information may be generated by processing the customer's social network activity using the techniques described previously.

The defined groups may be hierarchical. For example, a “disaster relief” group, or cluster, may be a higher node in a clustering hierarchy than the node associated with interest in a specific natural disaster. Server 220 may also populate the defined customer groups by associating a plurality of customers who have opted to link their social network profile associated with social network provider system 130 with their financial account with one or more of the defined groups based on traits identified for those customers (step 504). In certain embodiments, server 220 may execute software that performs cluster analysis processes known in the art. In some embodiments, the one or more groupings of customers may be defined using an unsupervised machine learning model. For example, the server 220 may identify similarities in customer interests while analyzing social network and transaction data.

In some embodiments, transaction data may be tagged with one or more identifiers to indicate the transaction type, recipient type (e.g., merchant, charitable organization, etc.), and/or interest associated with the recipient. For example, a customer's transaction history may include several transactions with a merchant, e.g., a pet store. Said transactions may be associated with tags, such as, for example, “pets,” “animals,” etc. The system may determine, based on one or more transaction tags, that a transaction was a charitable donation made by the customer to a charitable organization associated with one or more interests. Thus, transaction data may be used instead of or in addition to social network data to generate customer groupings.

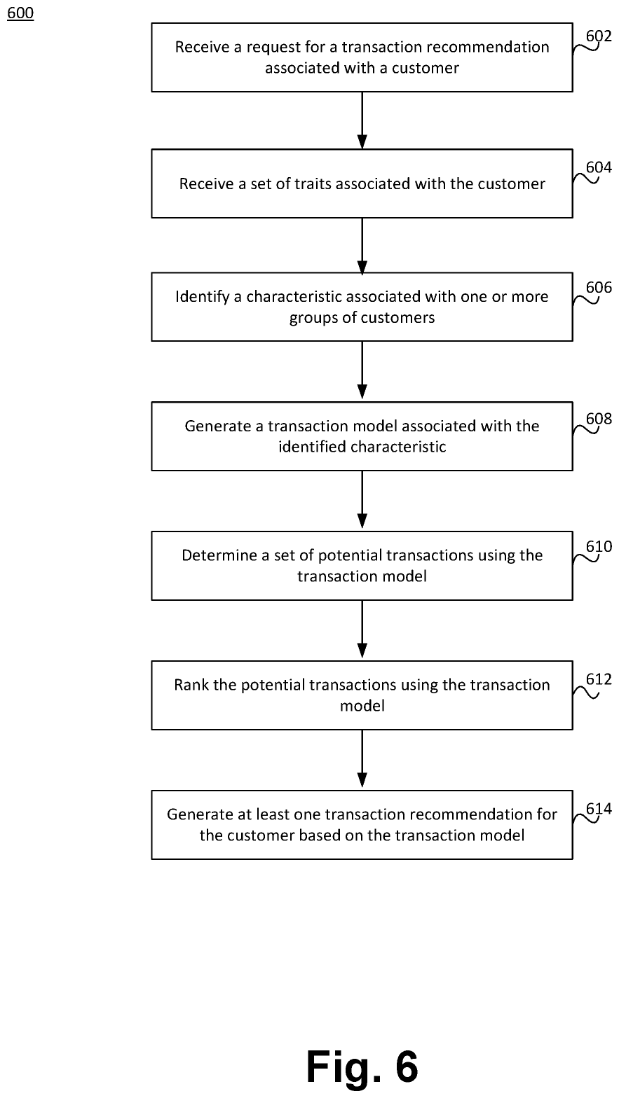

FIG. 6 is a flowchart of an exemplary method 600 for generating transaction suggestions, consistent with disclosed embodiments.

In step 602, server 220 may receive a request for a transaction recommendation. The request may be generated based on a customer's activity on a system of financial service provider 120, for example, via a web-based application. The request may also be generated on a periodic basis, for example, at a period of time predetermined by a transaction model, the predetermined period associated with a likelihood that the customer will make a donation. A period of time during which a customer may be more likely to make a donation may be, for example, a predetermined amount of time before or after a national holiday, a predetermined amount of time before or after a life event, etc. The predetermined period of time may be based on, for example, statistics indicating a larger number of donations are received by one or more organizations during the predetermined time before or after the national holiday than are received during other time periods.

In some embodiments, the predetermined time period may be an amount of time before or after a life event (e.g., marriage, promotion, birth of a child, etc.) of the customer. The system may receive information indicative of a life event from the user (e.g., as an account name change request, request to add a spouse to an account, etc.) or from a third-party database (e.g., from public records). In some embodiments, a life event may be identified using demographic information stored by the financial service provider system for events such as a customer's birthday. In another embodiment, the system may parse the social network information, e.g., posts published in the customer's feed, comments published by the customer, etc., associated with the customer to identify other life events, such as anniversaries, death of loved ones, etc. In another embodiment, social network information may indicate an activity of the customer, e.g., a honeymoon in Hawaii. Based on activity of the customer, e.g., a post containing the hashtag “#tbt” (“throwback Thursday”) and a picture with a geotag indicating it was taken in Hawaii, may indicate the customer is remembering his honeymoon. Thus, the system may generate donation recommendations for charities based in Hawaii, charities sponsoring beach clean-ups, etc.

At step 604, server 220 may receive a plurality of traits associated with the customer. The traits may be provided by, for example, database 227 in which the traits correspond to one or more tags associated with a charitable organization. As previously described, the traits may be based on social network information, financial information, or a combination of the two.

At step 606, server 220 may identify a characteristic associated with one or more groups to which the customer belongs. Server 220 may then generate a transaction model based on the identified characteristic (step 608). The transaction model may be generated using one or more learning processes trained on customer data. Customer data may include, for example, an indication of prior successful or unsuccessful donation recommendations. A successful recommendation may be a suggestion provided to a customer via an interface to which the customer positively responded by, for example, completing the recommended transaction or providing a positive ranking and/or relevance score. The generated transaction model may be based in part on one or more statistics stored in a third-party database 150, for example, average donation amount per household, average frequency of donations per household, etc.

At step 610, server 220 may use the transaction model to generate one or more recommended transactions. Based on the results of the transaction model, server 220 may rank the transactions, for example, based on a likelihood that the customer will complete the transaction (step 612). A recommended transaction may include a recommended amount and/or a recommended recipient. For example, server 220 may generate one or more recommended charitable donations, with each recommendation including an amount and a charitable organization to receive the amount. In some embodiments, one or more recommended charitable organizations may be generated from a database, e.g., database 150, containing charitable organization information. For example, database 150 may store charitable organization information that is continuously populated and updated based on identifying charities donated to by one or more customers.

In some embodiments, the one or more recommended transactions may be based on information stored in a database, e.g., database 105 or database 227. For example, charitable organizations associated with tags that are the same as or similar to the customer's determined interests may be included in the recommended transactions. Server 220 may use one or more algorithms to generate the recommended transactions. In some embodiments, server 220 may identify a conflict and exclude one or more charitable organizations from the recommendations. For example, a customer may interact with a church on a social media network and thus may be associated with interests of “religious organizations” and “Christian organizations.” A social network friend of the customer may interact with a synagogue on a social media network and thus may be associated with interests of “religious organizations” and “Jewish organizations.” In some embodiments, server 220 may determine the customer and the customer's friend are likely to have similar donation behavior based on their respective social media activity. However, although the customer is tagged as having an interest in “religious organizations,” the customer may be unlikely to donate to an organization affiliated with a different religion. Server 220 may determine that, based on the friend's social network activity, the customer may be likely to donate to a religious organization. Based on the customer's interaction with a Christian organization, server 220 may query database 150 for charitable organizations associated with the tags “religious organization” and “Christian organization.”

In some embodiments, the server 220 may rank the transactions. For example, transactions may be ranked based on relevance to the customer based on the number of tags associated with each organization that correlate to the determined interests of the customer. A higher number of similar tags may indicate the customer is more likely to make a donation to the organization. In another embodiment, server 220 may rank transactions based on each organization's trustworthiness or charity rating. For example, as previously described, the system may receive rating information (e.g., a ranking, trustworthiness score, rating, transparency score, efficiency score, etc.) for each organization from a third-party (e.g., a watchdog organization). The server 220 may rank the organizations by rating and only recommend, for example, the highest rated or most trustworthy organizations.

In step 614, server 220 may generate at least one transaction recommendation for the customer based on the transaction model. The recommendation may include, alone or in combination, a donation amount and a suggested recipient. The recommendation may be presented to the customer via display on a user device associated with the customer. In some embodiments, the recommendation may include a “quick pay” option for completing the transaction. The recommendation may include a menu including selectable options comprising one or more of the ranked transactions. In some embodiments, the customer may select or input an amount other than the recommended amount. In some embodiments, the customer may input or select a different amount and/or recipient than those recommended. For example, in some embodiments, the customer may select from a list containing the top three, five, ten, etc. transactions from the ranked list of recommended transactions.

In some embodiments, an indication that the customer completed a recommended transaction may be stored by database 227. Server 220 may use customer feedback information to further train one or more transaction models. For example, server 220 may generate an interface for the user to provide feedback. The interface may request that the customer input a rating of how appropriate the recommendation was to the customer's interests. In some embodiments, the interface may include a text field for the customer to input comments and/or feedback about the recommendation. The server 220 may analyze the textual input, e.g., using NLP techniques, to determine whether the recommendation was relevant to the customer and/or why the customer did not think the recommendation was relevant. For example, the server 220 may receive customer input: “I care more about people than animals.” Server 220 may execute NLP techniques and/or other processing methods to determine not to recommend charities that help animals to that customer, but to recommend charities that focus more on people as the beneficiaries. Such a determination may be stored, e.g., in database 150, and associated with the customer.

In some embodiments, server 220 may generate an interface showing the donation activity of the customer's friends and/or connections on one or more social networks. For example, if one or more of the customer's friends from a social media network have donated to the charity recommended to the customer (and have authorized their transaction data to be shared), server 220 may generate an interface through which the customer may view social network friends who have donated to the recommended charity. In some embodiments, the interface may display the dollar amounts of some or all of those transactions. In another embodiment, the interface may display aggregate data. For example, server 220 may determine and display that five of the customer's social network friends gave a total of $2500 over the past year.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented with hardware alone. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive.

Instructions or operational steps stored by a computer-readable medium may be in the form of computer programs, program modules, or codes. As described herein, computer programs, program modules, and code based on the written description of this specification, such as those used by the processor, are readily within the purview of a software developer. The computer programs, program modules, or code can be created using a variety of programming techniques. For example, they can be designed in or by means of Java, C, C++, assembly language, or any such programming languages. One or more of such programs, modules, or code can be integrated into a device system or existing communications software. The programs, modules, or code can also be implemented or replicated as firmware or circuit logic.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

1. A system for recommending transactions to customers based on customer characteristics, comprising:
at least one machine-readable memory storing computer-executable instructions; and
at least one processor configured to execute the instructions to perform operations comprising:
receiving a request for a transaction recommendation associated with a specified customer;
receiving a plurality of traits associated with the specified customer
wherein receiving the plurality of traits comprises:
accessing, via an application programming interface, social network data associated with the customer,
identifying, based on the social network data, one or more elements in content accessed by the customer; and
determining one or more interests of the user based on the one or more elements, wherein the one or more interests are associated with the plurality of traits;
identifying a characteristic associated with a customer group, based on the traits;
generating, by a machine learning process trained on customer data, a transaction model associated with the identified characteristic, the transaction model identifying potential transaction information associated with an entity by the customer group;
determining a plurality of potential transactions using the transaction model, each potential transaction being associated with a likelihood of the customer completing the potential transaction;
ranking the potential transactions using the transaction model; and
generating a transaction recommendation for the specified customer based on the transaction model, the transaction recommendation comprising a transaction amount and a transaction recipient to receive the transaction amount from the customer.

2. The system of claim 1, wherein the operations further comprise:
providing the transaction recommendation to the specified customer; and
receiving at least one of a notification that the specified customer has authorized the transaction or a notification that the specified customer has declined the transaction.

3. The system of claim 2, wherein the transaction recommendation comprises at least one of a recommended transaction amount or an identity of an entity.

4. The system of claim 1, wherein the entity comprises a charitable organization.

5. The system of claim 1, wherein the identified characteristic comprises at least one of a financial attribute, a geographic attribute, a demographic attribute, transaction history, or purchasing behavior.

6. The system of claim 1, wherein the transaction model comprises information associated with at least one of a financial attribute of the customer group, a geographic attribute of the customer group, a demographic attribute of the customer group, transaction history of the customer group, or purchasing behaviors of the customer group.

7. The system of claim 4, wherein the operations further comprise:
receiving charitable organization information from a database, the charitable organization information comprising charity spending information; and
determining that the charitable organization spends less than a threshold percentage of its donations on operational costs.

8. The system of claim 1, wherein the operations further comprise:
receiving, from a third-party database, rating information for the entity; and
ranking the potential transactions based on the rating information.

9. The system of claim 2, wherein the operations further comprise:
generating a graphical user interface configured to receive a dollar amount input by the user.

10. A computer-implemented method for recommending transactions to customers based on customer characteristics, comprising:
receiving a request for a transaction recommendation associated with a specific customer via a computer network;
receiving a plurality of traits associated with the customer
wherein receiving the plurality of traits comprises:
accessing, via an application programming interface, social network data associated with the customer,
identifying, based on the social network data, one or more elements in content accessed by the customer; and
determining one or more interests of the user based on the one or more elements, wherein the one or more interests are associated with the plurality of traits;
identifying, via one or more processors, a characteristic associated with a customer group based on the traits;
generating, by a machine learning process trained on customer data via the one or more processors, a transaction model associated with the identified characteristic, the transaction model identifying potential transaction information associated with an entity by the customer group;
determining a plurality of potential transactions using the transaction model, each potential transaction being associated with a likelihood of the customer completing the potential transaction;
ranking the potential transactions using the transaction model; and
generating a transaction recommendation for the specified customer based on the transaction model, the transaction recommendation comprising a transaction amount and a transaction recipient to receive the transaction amount from the customer.

11. The method of claim 10, further comprising:
providing the transaction recommendation to the specified customer, wherein the transaction information comprises a transaction amount.

12. The method of claim 11, further comprising:
receiving, via a client device, feedback from the specified customer indicating a relevance of the transaction recommendation to the specified customer; and
storing the feedback in a database.

13. The method of claim 12, further comprising:
training the transaction model based on received feedback from the customer group.

14. The method of claim 11, further comprising:
determining, based on the transaction model, a period of time for providing the transaction recommendation to the spccificd customer.

15. The method of claim 14, wherein the period of time comprises a seasonal period associated with a national holiday.

16. The method of claim 14, wherein the period of time comprises a period of time associated with a life event of the customer.

17. The method of claim 11, wherein the transaction recommendation comprises an amount based on the plurality of customer traits associated with the customer.

18. The method of claim 10, further comprising:
providing, via a graphical user interface, a predetermined number of the ranked potential transactions, wherein each displayed transaction is selectable by the user.

19. The method of claim 10, further comprising:
generating a graphical user interface configured to receive a custom transaction amount input by a user.

20. A non-transitory computer-readable medium storing instructions that, when executed by at least one processor, cause the at least one processor to perform operations comprising:
receiving a request for a transaction recommendation associated with a customer via a computer network;
receiving a plurality of traits associated with the customer wherein receiving the plurality of traits comprises:
accessing, via an application programming interface, social network data associated with the customer,
identifying, based on the social network data, one or more elements in content accessed by the customer; and
determining one or more interests of the user based on the one or more elements, wherein the one or more interests are associated with the plurality of traits;
identifying, via one or more processors, a characteristic associated with a customer group based on the plurality of traits;
generating, by a machine learning process trained on customer data via the one or more processors, a transaction model associated with the identified characteristic, the transaction model identifying potential transaction information associated with an entity by the customer group;
determining a plurality of potential transactions using the transaction model, each potential transaction being associated with a likelihood of the customer completing the potential transaction;
ranking the potential transactions using the transaction model; and
generating at least one transaction recommendation for the customer based on the transaction model, the at least one transaction recommendation comprising a transaction amount and a transaction recipient to receive the transaction amount from the customer.
